(19) United States
(12) Patent Application Publication
(10) Pub. No.: US 2017/0364856 A1
(43) Pub. Date: Dec. 21, 2017

(54) DECOMPOSITION OF MULTISITE HETEROGENEOUS WORKFORCE SCHEDULING PROBLEMS

(71) Applicant: International Business Machines Corporation, Armonk, NY (US)

(72) Inventors: Michael Katz, Nahariya (IL); Vladimir Lipets, Haifa, NY (US); Michael Masin, Haifa (IL); Dany Moshkovich, Yokneam Ilit (IL); Segev E. Wasserkrug, Haifa (IL)

(21) Appl. No.: 15/182,627

(22) Filed: Jun. 15, 2016

(51) Int. Cl. G06Q 10/06; G06N 7/00

(52) U.S. Cl. CPC G06Q 10/063112; G06N 7/005

(57) ABSTRACT

A computer-implemented method, computerized apparatus and computer program product for decomposing multisite heterogeneous workforce scheduling problems. An instance of a multisite heterogeneous workforce scheduling problem comprising a set of work items and a set of technicians is obtained. A measure of likelihood that a pair of work items belong to the same sub-problem in a decomposition of the problem instance into a plurality of sub-problems, such that a union of solutions to the plurality of sub-problems is a solution to the problem, is calculated. The measure calculation comprises calculating one or more components indicating a relation between the pair of work items and technicians potentially scheduled to execute either of them. A solution to the problem is generated by solving the plurality of sub-problems in the decomposition obtained based on a partitioning of the set of work items induced by the measure and aggregating solutions to the plurality of sub-problems.

### TECHNICAL FIELD

The present disclosure relates to scheduling problem decomposition in general, and to multisite heterogeneous workforce scheduling problem decomposition, in particular.

### BACKGROUND

Mobile workforce scheduling is a computationally challenging task. Mobile workforce scheduling is a task of assigning mobile agents to perform tasks, often at remote locations, during designated time frames. For example, in case of a telecommunications company having a fleet of technicians, and a set of service calls to be handled, the scheduling problem may include the selection of which service calls, and at what order, each technician would attend to.

Mobile workforce scheduling problems can be seen as variation of the vehicle routing problem with time windows (VRPTW) which is known to be NP-hard. Effective optimal solutions exist only for some relatively small problems and are not applicable to real life industrial cases. Several approximate heuristic techniques were developed to address some larger cases. However, with respect to large industrial scheduling problems for heterogeneous technicians originated from multiple sites, existing solutions still suffer from great inefficiency.

Bowerman et al., 1994 proposed a classification of heuristic approaches to solving VRPTW as follows: (1) cluster-first/route-second, (2) route-first/cluster-second, (3) savings/insertion, (4) improvement/exchange, and (5) constraints relaxation. See in R. L. Bowerman, P. H. Calamai, and G. B. Hall. “The spacefilling curve with optimal partitioning heuristic for the vehicle routing problem.” European Journal of Operational Research, 76(1), pp. 128-142, 1994, which is hereby incorporated by reference without giving rise to disavowment.

Dondo et al., 2007 presented a three-phase heuristic/algorithmic approach to the multi-depot routing problem with time windows and heterogeneous vehicles. See in R. Dondo and J. Cerdá. “A cluster-based optimization approach for the multi-depot heterogeneous fleet vehicle routing problem with time windows.” European Journal of Operational Research, 176(3), pp. 1478-1507, 2007, which is hereby incorporated by reference without giving rise to disavowment.

Qi et al., 2012 presented an approach which is based on spatiotemporal partitioning of work items. See in M. Qi, W. H. Lin, N. Li, and L. Miao. “A spatiotemporal partitioning approach for large-scale vehicle routing problems with time windows.” Transportation Research Part E: Logistics and Transportation Review, 48(1), pp. 248-257, 2012, which is hereby incorporated by reference without giving rise to disavowment. Their approach considers jointly the temporal and spatial information as part of the partitioning process. This is done by measuring the spatiotemporal distance between two customers and exploiting the measure for clustering. However, the approach of Qi et al. is focused on scheduling problems that are restricted to homogeneous technicians located at a single site. Thus, diversity among technicians and/or multiple depots is not considered in the afore-mentioned measure.

### BRIEF SUMMARY

One exemplary embodiment of the disclosed subject matter is a computer-implemented method comprising: obtaining an instance of a multisite heterogeneous workforce scheduling problem comprising a set of work items and a set of technicians; calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and generating a solution to the problem by solving the plurality of sub-problems in the decomposition obtained based on a partitioning of the set of work items induced by the measure and aggregating solutions to the plurality of sub-problems.

Another exemplary embodiment of the disclosed subject matter is computerized apparatus having a processor, the processor being adapted to perform the steps of: obtaining an instance of a multisite heterogeneous workforce scheduling problem comprising a set of work items and a set of technicians; calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and generating a solution to the problem by solving the plurality of sub-problems in the decomposition obtained based on a partitioning of the set of work items induced by the measure and aggregating solutions to the plurality of sub-problems.

Yet another exemplary embodiment of the disclosed subject matter is a computer program product comprising a non-transitory computer readable storage medium retaining program instructions, which program instructions when read by a processor, cause the processor to perform a method comprising: obtaining an instance of a multisite heterogeneous workforce scheduling problem comprising a set of work items and a set of technicians; calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and generating a solution to the problem by solving the plurality of sub-problems in the decomposition obtained based on a partitioning of the set of work items induced by the measure and aggregating solutions to the plurality of sub-problems.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the subject matter;

FIGS. 2A-2D show schematic illustrations of scheduling relations, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

One technical problem dealt with by the disclosed subject matter is to decompose a scheduling problem with heterogeneous workforce and/or multiple depots into smaller problem instances, whereby a feasible and efficient solution to the original problem may be obtained by solving each of the smaller problems and aggregating their solutions together.

A scheduling problem is a problem of scheduling tasks to agents, e.g., assigning work items to technicians for execution. In mobile workforce scheduling problems, the technicians are mobile and required to arrive at the location where the work item is to be executed, thus the traveling time spent also has to be taken into account in the scheduling. In multisite scheduling problems there are multiple depot locations from which technicians may originate and/or to which they return after completion, thus leading to differences in traveling times among technicians with respect to given work items. In heterogeneous workforce scheduling problems, the technicians differ from one another by one or more parameters, such as shifts, skills, associated depot locations, or the like. For example, some technicians may be better than others in executing some types of work items, or able to perform certain work items that others cannot. Typically, each work item has an assigned timeframe for starting and for ending, e.g., a work item to be performed between 12:00-15:00. Additionally or alternatively, work items are associated with an estimated duration or handling time, which may vary from one technician to another, such as based on the technician's skill, historic information regarding handling similar work items, or the like. Some instances of scheduling problems are aimed at assigning to each work item a technician to execute it, while maintaining time limitations on handling each of the work items, and/or while optimizing a target function, such as by minimizing a cost function, which may take into account technician's wages, cost of travel, customers' satisfaction, or the like.

Another technical problem dealt with by the disclosed subject matter is to provide a measure for clustering work items that addresses disparities among technicians to which they are to be scheduled, in addition to spatiotemporal distances between the work items.

One technical solution is to incorporate technician related information within the spatiotemporal decomposition process. For each pair of work items, a measure of likelihood that both work items belong to the same group in a partitioning of the original scheduling problem to a plurality of sub-problems is calculated, the measure comprising one or more components indicative of a relation between the pair of work items and technicians potentially scheduled for executing either of them. The relation may be provided in the form of a utility function or benefit value of scheduling either of the pair of work items to a technician in question.

In some exemplary embodiments, one component may indicate the benefit of a certain technician executing both work items. The component may comprise one or more sub-components indicative of a relation between characterizing parameters of the technician and the two work items, whether spatial, temporal or otherwise. For example, one sub-component may reflect the amount of time that is left for other work items within the technician's shift given that the pair of work items are scheduled to be executed by that technician. As another example, one sub-component may reflect the flexibility level in scheduling the two work items within the technician's shift, i.e. in the selection of the s execution time of each of the two work items. As yet another example, one sub-component may reflect the fragmentation level of the technician's shift due to the pair of work items being scheduled thereto. In some exemplary embodiments, the sub-components may take into account the estimated time needed to execute both work items. Additionally or alternatively, the sub-components may account for traveling time from one location to another, e.g., from the technician's start location and/or to the technician's end location, between locations of work items, or the like. In some exemplary embodiments, the component may be calculated as a weighted sum of its sub-components.

In some exemplary embodiments, one component may indicate the benefit of the two work items belonging to the same group in a decomposition of the problem assuming a certain pair of technicians being assigned to execute them. The component may reflect a level of substitutability between the two technicians with respect to the pair of work items.

In some exemplary embodiments, the measure calculation may comprise computing for each technician the benefit of scheduling the pair of work items thereto and summing over all technicians. In some exemplary embodiments, the measure calculation may comprise computing for each pair of technicians the benefit of assigning the pair of work items to them and summing over all pairs of technicians. In some exemplary embodiments, the measure may be calculated as a weighted sum of the two summations. In some exemplary embodiments, in case the benefit components are not symmetrical, the measure may be calculated by taking the maximum of the two values.

In some exemplary embodiments, the measure computed may be used in a decomposition process according to any one of available measure-based VRPTW decomposition methods, such as disclosed by Qi et al. for partitioning work items. In some further exemplary embodiments, given the partitioning of the work items based on the calculated measure, a partitioning of the technicians may be performed based on a relationship between spatiotemporal parameters of the work items and occupational parameters of the technicians, to obtain thereby a plurality of smaller problem instances that may be solved efficiently.

One technical effect of utilizing the disclosed subject matter is to handle decomposition of a VRPTW with heterogeneous technicians and multiple depots.

Another technical effect of utilizing the disclosed subject matter is to provide a decomposition measure that links a pair of work items indirectly through technicians.

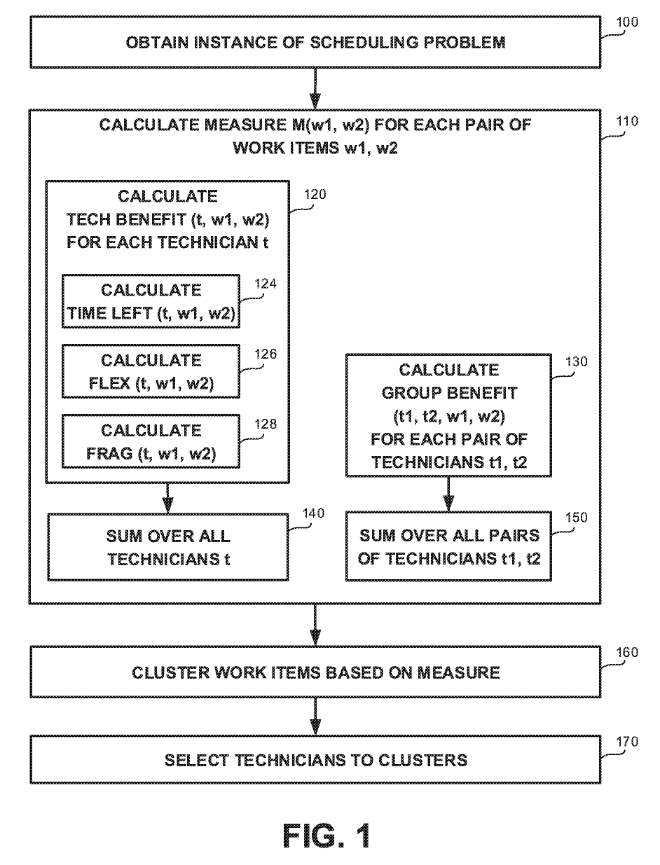

Referring now to FIG. 1 showing a flowchart diagram of a method, in accordance with some exemplary embodiments of the subject matter.

On Step 100, an instance of a scheduling problem may be obtained. The problem instance may be obtained in a computer-readable form. The scheduling problem may comprise a set of work items and a set of technicians for executing them. The work items may be associated with one or more spatiotemporal parameters, such as location, estimated duration, a time frame during which the job is required to be done, or the like. The technicians may be associated with one or more occupational parameters, such as shifts, skills, associated depot locations, or the like.

On Step 110, for each pair of work items w1 and w2, a measure M(w1, w2) indicating the likelihood of the two work items belonging to the same group in a decomposition of the problem obtained on Step 100 into a plurality of sub-problems may be calculated. In some exemplary embodiments, the measure may comprise one or more components indicating a relation between the pair of work items and one or more technicians to which they are potentially scheduled for execution.

On Step 120, for each technician t, a component TechBenefit(t, w1, w2) indicating the benefit in scheduling the pair of work items w1, w2 for execution by the technician t, may be calculated. In some exemplary embodiments, in case that the technician cannot execute either of the work items from any reason, the value of this component may be set to zero. For example, if one of the work items is associated with a time frame that falls outside of the technician's shift, requires a certain skill that the technician does not have, or the like, then TechBenefit(t, w1, w2)=0.

On Step 124, a sub-component TimeLeft(t, w1, w2) indicating the amount of time left for other work items within the shift of the technician t after the two work items w1, w2 have been scheduled to be executed by the technician t, may be calculated. In some exemplary embodiments, the calculation may take into account the time needed to execute both work items, as well as the time required for all necessary moves, i.e. from one location to another, from technician is start location, and to technician is end location.

On Step 126, a sub-component Flexibility(t, w1, w2) indicating the level of flexibility in selection of the execution time of the two work items w1, w2 within the shift of the technician t may be calculated. This sub-component may be calculated as the sum of time windows along which w1 and/or w2 can be started at any point, assuming that both of the work items are executed within the shift. For example, the computation may be performed by adding up the time frames during which each of the work items are required to be executed, and subtracting the time required by the technician t for executing the two work items, optionally including travelling time. In some exemplary embodiments, rather than a continuous slot, the time frame allotted for a work item may comprise a discrete number of scheduling options. The flexibility level may be computed as the total number of possible schedulings of the two work items within the shift, e.g. a multiplication of the number of options for w1 by the number of options for w2.

On Step 128, a sub-component Fragmentation(t, w1, w2) indicating the potential of minimizing the level of fragmentation in the available and occupied time of the technician t when scheduled to execute the pair of work items w1, w2. This sub-component may be computed as the size of the largest possible free interval within is shift when both work items are executed.

In some exemplary embodiments, the component TechBenfit(t, w1, w2) may be calculated based on one or more of the sub-components computed on Steps 124 to 128. For example, TechBenfit(t, w1, w2) may be calculated as a weighted sum of the three components TimeLeft(t, w1, w2), Flexibility(t, w1, w2), and Fragmentation(t, w1, w2), using a predetermined set of weights {a1, a2, a3}.

On Step 130, a component GroupBenefit(t1, t2, w1, w2) indicating the benefit of the two work items w1 and w2 belonging to the same sub-problem instance in a partitioning of the original problem instance obtained on Step 100 while being scheduled to be executed by the pair of different technicians t1 and t2, may be calculated. This component may be calculated as the amount of overlapping in time between the intervals during which technician t1 can start executing work item w1 and technician t2 can start executing work item w2. In case that one of the technicians cannot execute either of the work items, for example, due to the work item in question requiring a skill the technician does not have, or falling outside the technician's shift, or the like, the value may be set to zero.

On Step 140, a summation of the component TechBenefit(t, w1, w2) computed on Step 120 for each technician t may be performed over all technicians.

On Step 150, a summation of the component GroupBenefit(t1, t2, w1, w2) computed on Step 130 for each pair of technicians t1 and t2 may be performed over all pairs of technicians.

In some exemplary embodiments, the measure M(w1, w2) may be calculated a weighted sum of the components summations computed on Steps 140 to 150, using a predetermined set of weights {b1, b2}. In case the sum is not symmetric for the two different orderings of the pair of work items as arguments in any of the components and/or subcomponents, the measure M(w1, w2) may be computed as a symmetric function of the summations. For example, denoting by T(w1, w2) the summation over all technicians t of TechBenefit(t, w1, w2), by G(w1, w2) the summation over all pairs of technicians t1, t2 of GroupBenefit(t1, t2, w1, w2), and by m(w1, w2) the weighted sum of T(w1, w2) and G(w1, w2), the measure M(w1, w2) may be defined as: max{m(w1,w2),m(w2,w1)}; (m(w1,w2)+m(w2,w1))/2; or the like.

On Step 160, the work items may be clustered into a plurality of sub-groups based on the measure calculated on Step 110 for each pair. The clustering may be performed using any suitable clustering techniques, such as disclosed by Qi et al., for example. The clustering may be purported to put pairs of work items for which the value of the measure is high at the same cluster or sub-group, while pairs for which that value is low are put in two separate clusters.

On Step 170, given the partitioning of the work items obtained on Step 160, technicians may be selected to clusters to obtain a partition of the scheduling problem into plurality of sub-problems. In some exemplary embodiments, the technician selection may be cast as an optimization problem. For example, the occupational parameters associated with each of the technicians, such as shifts, skills, and the like, may be considered as constraints to be satisfied by the selection of technicians to clusters of work items, and the distances between the locations of the work items and the technicians' associated depots may be the objective function to be minimized. Alternatively, a greedy s approach may be used, wherein at each iteration, a technician is selected for the most critical partition, given the technicians already assigned. Such critical partition may be the one consisting of work items which can be executed by that technician only. Thus, technicians may be ordered by their uniqueness for work items.

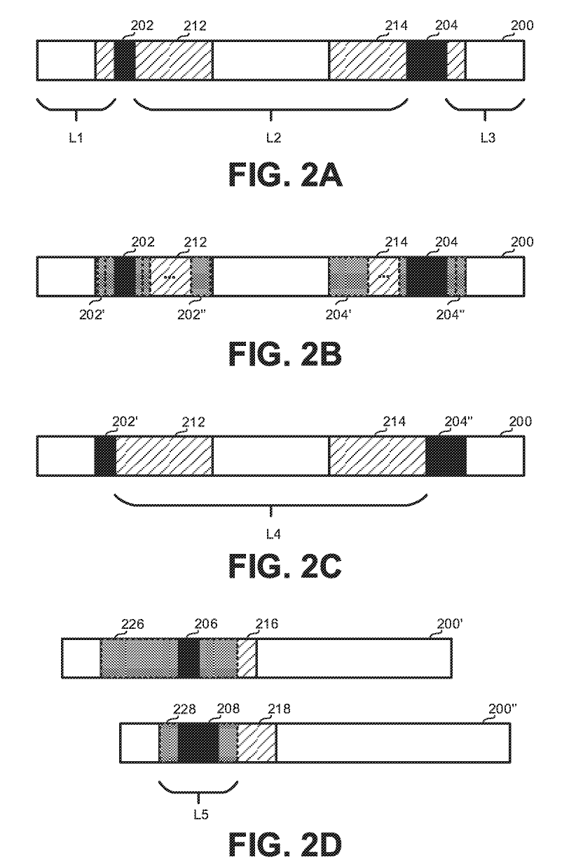

Referring now to FIGS. 2A-2D showing schematic illustrations of scheduling relations in accordance with some exemplary embodiments of the disclosed subject matter.

FIG. 2A illustrates an example of a relation between a pair of work items and a technician to which they are assigned for execution.

A technician may be associated with a Shift 200, having a defined start time, end time and resulting length. A first work item may be assigned a Scheduling 202, defining respective start and end times. Similarly, a second work item may be assigned a Scheduling 204. Each of Schedulings 202 and 204 may comprise the estimated duration for executing the respective work item by the technician. In some exemplary embodiments, Schedulings 202 and 204 may further comprise the traveling time required to arrive and return from each location, given the associated depot location of the technician at start and/or end. Each of the first and second work items may be associated with a time frame, such as Timeframe 212 and Timeframe 214, during which the respective work item is required to be executed. Accordingly, Scheduling 202 may schedule the first work item within the Timeframe 212 associated therewith, and Scheduling 204 may similarly schedule the second work item within its corresponding Timeframe 214, as exemplified in FIG. 2A.

A relation of the amount of free time left to the technician within the shift after scheduling the first and second work items, similarly as computed on Step 122 of FIG. 1, is further exemplified in FIG. 2A. The time left may be computed by adding up the time intervals before, in between, and/or after the schedulings of the two work items within Shift 200, denoted in FIG. 2A by L1, L2, and L3, respectively.

FIG. 2B illustrates another example of a relation between a pair of work items and a technician to which they are assigned for execution.

As exemplified in FIG. 2B, the Timeframe 212 associated with the first work item may accommodate different schedulings thereof, such as Schedulings 202′ and 202″, in addition to Scheduling 202 as in FIG. 2A. Similarly, Timeframe 214 may accommodate alternate options for scheduling the second work item, other than Scheduling 204 as in FIG. 2A, such as the exemplary additional Schedulings 204′ and 204″. Accordingly, a relation of the flexibility level in selection of a scheduling for both the first and second work items within Shift 200, similarly as computed on Step 124 of FIG. 1, is exemplified in FIG. 2B by the different options accommodated in each of the Timeframes 212 and 214.

FIG. 2C illustrates yet another example of a relation between a pair of work items and a technician to which they are assigned for execution.

As exemplified in FIG. 2C, a selection of one of the multiple scheduling options available for each of the two work items as shown in FIG. 2B, such as Scheduling 202′ for the first work item, which is the earliest possible at Timeframe 212, and Scheduling 204″ for the second work item, which is the latest possible given Timeframe 214, may maximize the size of at least one of the free time intervals along Shift 200 induced by such choice. The number of intervals induced by the scheduling of the two work items may go up to three, such as L1, L2 and L3 of FIG. 2A. In case the two work items are scheduled successively one after another, where possible, the number of resulting free intervals would be two or one, depending on whether the scheduling lies at one of the extreme points of the shift (one interval, either before or after) or in the middle (two intervals, one before and the other after).

Accordingly, a relation of the potential to minimize the level of fragmentation of occupied and free time intervals within the technician's shift may be calculated as the size of the largest possible free interval, denoted in FIG. 2C as L4.

FIG. 2D illustrates an example of a relation between a pair of work items and a pair of technicians to which they are assigned for execution.

A first technician may be associated with a Shift 200′, having a defined start time, end time and resulting length, similarly as Shift 200 in FIGS. 2A-2C. A second technician may be associated with a Shift 200″, which may be partially overlapping with Shift 200′. A first work item may be assigned to the first technician for execution during a defined time slot, such as at Scheduling 206. Similarly, a second work item may be assigned to the second technician for execution at Scheduling 208. The interval occupied by each of Schedulings 206 and 208 may reflect the estimated time required by the s respective technician to execute the scheduled work item, optionally including the traveling time from an origin to a destination location, e.g. from a source depot to a work item's location, from the work item's location to a target depot, or the like.

In some exemplary embodiments, each of the first and second work items may be associated with a time window during which the work item is required to be executed, such as Timeframe 216 for the first work item and Timeframe 218 for the second work item, similarly as Timeframes 212 and 214 of FIGS. 2A-2C. Timeframe 216 may provide either a time interval or a plurality of optional time points at which the first technician may start executing the first work item, denoted in FIG. 2D as Interval 226. Similarly, Timeframe 218 may provide Interval 228 comprising all possible time points at which the second work item may be scheduled to start. As can be readily understood, a work item cannot be scheduled earlier than when the time frame associated with it starts, nor later than a point preceding the time frame's ending by the amount of time required for executing the task or less.

Accordingly, a relation of the degree of substitutability between the two technicians with respect to the pair of work items may be calculated as the amount of overlap between the time intervals or time points at which the first technician may start executing the first work item and the second technician may start executing the second work item, denoted in FIG. 2D as L5.

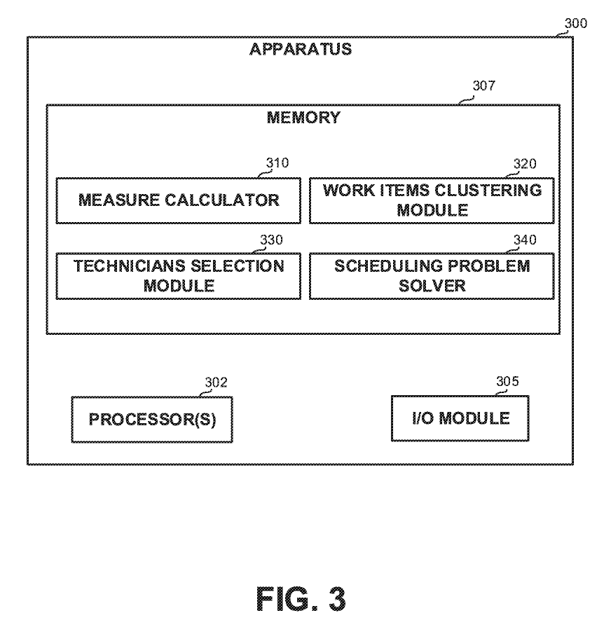

Referring now to FIG. 3 showing an apparatus in accordance with some exemplary embodiments of the disclosed subject matter. An Apparatus 300 may be configured to provide solution to VRPTW with heterogeneous workforce and multiple depots, in accordance with the disclosed subject matter.

In some exemplary embodiments, Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) module 305. I/O Module 305 may be utilized to provide an output to and receive input from a user, such as define the problem, provide hints to modifications, review solutions, or the like.

In some exemplary embodiments, Apparatus 300 may comprise Memory 307. Memory 307 may be a hard disk drive, a Flash disk, a Random Access Memory (RAM), a memory chip, or the like. In some exemplary embodiments, Memory 307 may retain program code operative to cause Processor 302 to perform acts associated with any of the subcomponents of Apparatus 300.

Measure Calculator 310 may be configured for calculating a measure of likelihood that a pair of work items belong to the same sub-problem in a decomposition of a scheduling problem, similarly as in Step 110 of FIG. 1. The scheduling problem may be a multisite and/or heterogeneous workforce scheduling problem. Measure Calculator 310 may be configured for calculating a component indicating a relation between a pair of work items and a technician potentially assigned to execute both of them, similarly as in Step 120 of FIG. 1; calculating a component indicating a relation between a pair of work items and a pair of technicians potentially assigned to execute either of them, similarly as in Step 120 of FIG. 1; calculating any sub-component of the component indicating a relation between a pair of work items and a technician, similarly as in any of Steps 122 to 126 of FIG. 1; calculating a summation of either components over all technicians or pairs of technicians, similarly as in Steps 140 and 150 of FIG. 1; calculating a weighted sum of components, sub-components, and/or summations; calculating a symmetric function of the sum of components, sub-components, and/or summations; or the like.

Work Items Clustering Module 320 may be configured for partitioning work items into a plurality of sub-groups based on the measure calculated by Measure Calculator 310 for each pair of work items.

Technicians Selection Module 330 may be configured for assigning technicians to the sub-groups determined by Work Items Clustering Module 320 to obtain thereby a plurality of sub-problems of the original scheduling problem. Technicians Selection Module 330 may determine the partitioning through casting to and solving of an optimization problem. Alternatively, Technicians Selection Module 330 may apply a greedy approach wherein technicians are iteratively selected to clusters consisting of work items that only they can perform.

Scheduling Problem Solver 340 may be configured for solving each of the plurality of sub-problems as decomposed from the original scheduling problem by Work Items Clustering Module 320 and Technicians Selection Module 330. Scheduling Problem Solver 340 may be further configured for aggregating the solutions to the plurality of sub-problems into a solution for the original scheduling problem.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data s processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining an instance of a multisite heterogeneous workforce scheduling problem comprising a set of work items and a set of technicians;
calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and
generating a solution to the problem by solving the plurality of sub-problems in the decomposition obtained based on a partitioning of the set of work items induced by the measure and aggregating solutions to the plurality of sub-problems.

2. The computer-implemented method of claim 1, wherein the relation is based on one or more spatiotemporal parameters associated with each of the work items selected from the group consisting of: location; estimated duration; time frame during which the work item is to be executed; or any combination thereof.

3. The computer-implemented method of claim 1, wherein the relation is based on one or more occupational parameters associated with each of the technicians selected from the group consisting of: shifts; skills; associated depot locations; or any combination thereof.

4. The computer-implemented method of claim 1, wherein the one or more components comprise a component indicative of a benefit of a same technician executing the pair of work items.

5. The computer-implemented method of claim 4, wherein the component comprises a sub-component indicative of available time left to the technician after deduction of the time required for executing the pair of work items.

6. The computer-implemented method of claim 4, wherein the component comprises a sub-component indicative of a flexibility level among possible schedulings of the pair of work items for execution by the technician.

7. The computer-implemented method of claim 4, wherein the component comprises a sub-component indicative of a fragmentation level minimization potential in scheduling of the pair of work items for execution by the technician.

8. The computer-implemented method of claim 4, wherein said calculating comprises performing a summation of the component over all technicians.

9. The computer-implemented method of claim 1, wherein the one or more components comprise a component indicative of a benefit of a pair of different technicians executing the pair of work items.

10. The computer-implemented method of claim 9, wherein said calculating comprises performing a summation of the component over all pairs of technicians.

11. The computer-implemented method of claim 1, further comprising partitioning the set of technicians based on a partitioning of the set of work items induced by the measure, whereby the decomposition of the problem instance into a plurality of sub-problems is obtained.

12. A computerized apparatus having a processor, the processor being adapted to perform the steps of:
obtaining an instance of a multisite heterogeneous workforce scheduling problem comprising a set of work items and a set of technicians;
calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and
generating a solution to the problem by solving the plurality of sub-problems in the decomposition obtained based on a partitioning of the set of work items induced by the measure and aggregating solutions to the plurality of sub-problems.

13. The computerized apparatus of claim 13, wherein the relation is based on one or more spatiotemporal parameters associated with each of the work items selected from the group consisting of: location; estimated duration; time frame during which the work item is to be executed; or any combination thereof.

14. The computerized apparatus of claim 13, wherein the relation is based on one or more occupational parameters associated with each of the technicians selected from the group consisting of: shifts; skills; associated depot locations; or any combination thereof.

15. The computerized apparatus of claim 13, wherein the one or more components comprise a component indicative of a benefit of a same technician executing the pair of work items.

16. The computerized apparatus of claim 15, wherein the processor is further adapted to perform a summation of the component over all technicians.

17. The computerized apparatus of claim 13, wherein the one or more components comprise a component indicative of a benefit of a pair of different technicians executing the pair of work items.

18. The computerized apparatus of claim 17, wherein the processor is further adapted to perform a summation of the component over all pairs of technicians.

19. The computerized apparatus of claim 13, wherein the processor is further adapted to partition the set of technicians based on a partitioning of the set of work items induced by the measure, whereby the decomposition of the problem instance into a plurality of sub-problems is obtained.

20. A computer program product comprising a non-transitory computer readable storage medium retaining program instructions, which program instructions when read by a processor, cause the processor to perform a method comprising:
obtaining an instance of a multisite heterogeneous workforce scheduling problem comprising a set of work items and a set of technicians;
calculating a measure of likelihood that a pair of work items belong to the same sub-problem in a decomposition of the problem instance into a plurality of sub-problems such that a union of solutions to the plurality of sub-problems is a solution to the problem, said calculating comprises calculating one or more components indicating a relation between the pair of work items and technicians potentially scheduled to execute either of them; and
generating a solution to the problem by solving the plurality of sub-problems in the decomposition obtained based on a partitioning of the set of work items induced by the measure and aggregating solutions to the plurality of sub-problems.
